(19) United States
(12) Patent Application Publication
(10) Pub. No.: US 2017/0247286 A1
(43) Pub. Date: Aug. 31, 2017

(54) COATINGS FOR SOLAR APPLICATIONS

(71) Applicant: B.G. NEGEV TECHNOLOGIES AND APPLICATIONS LTD., AT BEN-GURION UNIVERSITY, Beer-Sheva (IL)

(72) Inventor: Jacob HORMADALY, Omer (IL)

(73) Assignee: B.G. NEGEV TECHNOLOGIES AND APPLICATIONS LTD., AT BEN-GURION UNIVERSITY, BEER-SHEVA (IL)

(21) Appl. No.: 15/504,838

(22) PCT Filed: Aug. 17, 2015
(86) PCT No.: PCT/IL2015/050830

§ 371 Date: Feb. 17, 2017

Related U.S. Application Data
(60) Provisional application No. 62/038,372, filed on Aug. 18, 2014.

(51) Int. Cl. C03C 8/16; C03C 8/02; F24J 2/48; C03C 3/064; C09D 183/04; C09D 7/12; C09D 5/32; C03C 4/02

(52) U.S. Cl. CPC C03C 8/16; C09D 5/32; C03C 8/02; C03C 4/02; C03C 3/064; C09D 183/04; C09D 7/1216; F24J 2/488; C03C 2204/00; C03C 2207/04; F24J 2002/4683

(57) ABSTRACT

The invention relates to a composition for producing a solar absorber coating, comprising a silicone resin formulated with: (i) at least one compound selected from the group consisting of black ruthenium oxides and black spinel; and (ii) a glass powder. A method of applying the composition and coatings formed are also provided.

An ideal solar absorber is a coating with very high absorptance in the solar portion of the spectrum (UV, VIS and near IR), low emissivity at the working temperature, high chemical durability, good mechanical stability and low cost. Most of the materials in use today have some drawbacks such as thermal degradation at high temperature, instability on exposure to UV radiation, oxidation, and some materials do not protect the steel pipes used in the solar collector from corrosion.

For solar tower applications and other applications which are based on absorption of the solar energy and its conversion to heat, there is a need for high temperature black material as solar absorber which is compatible with steel such as carbon steel, stainless steel, Inconel™ and special alloys. The solar absorber should also have high absorption in the solar portion of the spectrum (UV, VIS and near IR), exhibit stability at high temperatures (e.g. 400-700° C.), withstand thermal cycling between room temperature to temperatures in the range of 400-700° C. and be easily applied onto metal substrates.

In WO 2012/127468, we reported the preparation of black coatings for solar applications, based on black ruthenium compounds and a glass powder, formulated in an organic vehicle, in the presence of additional metal oxide(s). The resultant formulation with paste consistency was applied onto Inconel™ substrates and on curing/firing, coatings were formed displaying very high solar absorptivity.

It has now been found that silicone resins can be formulated with black ruthenium oxide and/or a black spinel in the presence of a glass powder to form heat-curable formulations with broad range consistency spanning the low viscosities typical to paints and higher viscosities typical to pastes. Application of the formulated silicone resin, especially as a paint formulation, onto a stainless steel substrate followed by heat-curing, e.g., at temperature not higher than 400° C., results in the cross-linking of the silicone, to give a black coating with very strong adhesion to the metal substrate. It has been also observed that on exposure to temperature higher than the curing temperature, the silicone resin transforms into a white powder which is amorphous SiO₂. In fact, the transformation to SiO₂ probably starts during the curing stage but the transformation rate is slow; fast and almost complete transformation to SiO₂ occurs when a cured paint formulation is subjected to 1 hour at 650° C., or at higher temperature, in air atmosphere. Without wishing to be bound by theory, it is assumed that after the curing, the cross-linked silicone resin accounts for the good adhesion of the coating. On exposure to high temperatures, the silicone resin transforms to SiO₂, which in turn combines with the softened glass component to form a SiO₂-rich glass which acts as an inorganic “glue” of the coating. Hereinafter, the term “indigenously-formed SiO₂” is sometimes used to describe the SiO₂ which comes from the silicone resin on exposing same to high temperatures.

Accordingly, one aspect of the invention relates to a composition for producing a solar absorber coating, comprising a silicone resin formulated with:

(i) at least one compound selected from the group consisting of black ruthenium oxides and black spinel; and

(ii) a glass powder.

Silicone resins suitable for use in the invention are silicone resins for high temperature paints, with aryl (e.g., phenyl) groups attached to the silicone backbone, namely, poly(alkylarylsiloxane), e.g., poly(methylphenylsiloxane), or poly(diarylsiloxane), for example, poly(diphenylsiloxane). The siloxane may be functionalized with chemical groups, for example, hydroxyl. Workable silicone resins are commercially available as solutions of polysiloxane in solvents or as pure resins, from various manufacturers such as Dow Corning. In the experimental work illustrated below, a commercial high temperature paint, Pyromark® 2500 from LA-CO industries, was filtered to isolate the siloxane and the solvents from the solids, and the filtrate was used to produce the formulations of the invention.

The term ‘black ruthenium oxide’ is used herein to indicate all oxide compounds of ruthenium, which are black. The term is not limited to ruthenium dioxide alone; it encompasses also ruthenium-containing mixed metal oxides. Thus, black ruthenium oxide for use in the invention is selected from the group consisting of:

ruthenium dioxide RuO₂;

mixed oxides, including a ruthenium-containing spinel, for example, Co₂RuO₄, Co₂₊ₓRu₁₋ₓO₄ with x=0 to 0.5; Co_{2+x-y}M_{y}Ru₁₋ₓO₄ with M=transition metals such as Cu, Zn, Fe, Mn, Cr and y=0 to 0.75; a ruthenium-containing pervoskite, such as M′RuO₃ where M′=Ca, Sr, Ba;

mixed oxides such as Sr₂RuO₄;

alkali ruthenates; pyrochlores and substituted pyrochlores of Ru, such as the compounds described in U.S. Pat. No. 3,583,931 and U.S. Pat. No. 3,681,262 and those reported by Longo et al. [Materials Research Bulletin 4, p. 191 (1969)]; Lead free pyroclores such as Nd_{1.75}Cuo_{0.25}Ru₂O_{6+δ};

any precursor of ruthenium, which converts to an oxidized form of ruthenium at high temperatures, for example, the chloride of ruthenium and the ruthenium metal.

A black spinel pigment suitable for use in the invention is a mixed oxide of the general formula AB₂O₄. In an ideal normal spinel, the A site of the tetrahedral site is usually occupied by a divalent cation and the B site of the octahedral site is occupied by a trivalent cation. However, metals with higher and lower oxidations states such as A¹⁺, B⁴⁺, B⁵⁺ can also be accommodated in the spinel structure. Black transition metal spinels for use in the invention are mixed oxides of the general formula AB₂O₄ wherein the divalent and trivalent cations are preferably selected from the group consisting of cu²⁺, co²⁺, Fe²⁺, Mn²⁺, Ni²⁺, Fe³⁺, Cr³⁺ and Mn³⁺. It should be understood that the A site may be occupied by more than one type of a divalent and trivalent metal, and likewise, the B site may be occupied by more than one type of a trivalent and divalent metal. Preferred black inorganic pigments for the purpose of this invention are based on cobalt-iron-chromium mixed oxide with spinel structure, i.e., (Co,Fe) (Fe,Cr)O₄. In the experimental work performed in support of the invention, a commercially available pigment, Ferro F6333 having the chemical formula (Co,Fe) (Fe,Cr)O₄ (chemically named iron cobalt chromite black spinel) has been found suitable for coloring silicone resins-based formulations. The commercial black spinel pigment also contains quartz which stabilizes the spinel. By example, XRD of F6333 shows diffraction lines of quartz. At high temperatures >600° C. the quartz dissolves in the glass component of the composition of the invention.

Glass compositions suitable for use in the invention contain silicon dioxide, titanium dioxide and a mixture of alkali metal oxides as main components, with mole percentage in the ranges from 25.0-50.0%, 5.5-35.0% and 19.0-45.0%, respectively. Additional glass components are selected from the group consisting of boric oxide B₂O₃, bismuth oxide Bi₂O₃, aluminum oxide Al₂O₃, tin dioxide SnO₂, zirconium dioxide ZrO₂ and niobium oxide Nb₂O₅. Workable compositions are identified in Table 1 below (in terms of the glass ingredients and their respective molar concentrations). It should be noted that the glass compositions set out in Table 1 refer to glasses useful as starting materials for preparing the coating paint formulations of the invention. On exposing the coating to temperatures higher than the curing temperature, the composition of the glasses undergoes a significant change due to the incorporation of the indigenously-formed SiO₂ into the glass.

TABLE 1
(glass useful as starting materials)

| Ingredients | Range in mole % | Preferred range in mole % |
|---|---|---|
| SiO₂ | 25.0-50.0 | 30-45 |
| TiO₂ | 10.0-35.0 | 15-20 |
| M₂O (M = Na, K, Li or | 20.0-45.0 | 35-45 |
| their mixture) | | |
| B₂O₃ | 0-10.0 | 3-7 (e.g., 4-6) |
| Bi₂O₃ | 0-15.0 | 0-2 |
| ZrO₂ | 0-5.0 | 0-2 |
| Al₂O₃ | 0-7.0 | 0.5-4 (e.g., 1-4) |
| SnO₂ | 0-15.0 | 0.5-4 (e.g., 1-4) |
| Nb₂O₅ | 0-7.0 | 0-3 |
| CoO | 0-5.0 | 0-5 |
| NiO | 0-5.0 | 0-5 |
| MnO | 0-5.0 | 0-5 |
| CuO | 0-5.0 | 0-5 |
| FeO | 0-5.0 | 0-5 |

An especially preferred glass starting material to be formulated with the silicone resin solution comprises 30 to 45 mole % SiO₂, 15 to 20 mole % TiO₂; 8 to 15 mole % K₂O; 10 to 22 mole % Na₂O; 3 to 11 mole % Li₂O; 3 to 7 mole % B₂O₃; 1 to 3 mole % SnO₂; and one or more of the following oxides: 0.5 to 4 mole % Al₂O₃; 0 to 2 mole % Bi₂O₃ and 0 to 2 mole % ZrO₂.

It should be noted that part the alkali oxides indicated in Table 1 may be substituted by the corresponding fluorides, for example, NaF may be a used instead of Na₂O, LiF may be a substitute for Li₂O and KF may be a substitute for K₂O.

Glass powders with the compositions set forth in Table 1 are prepared by weighing the individual metal compound powders according to the recipe (sometimes precursors of the oxide may be used, e.g. NaHCO₃, Na₂CO₃ and NaNO₃ can be used instead of Na₂O) and thoroughly mixing same to give a uniform blend, following which the blend is melted in a crucible (e.g., platinum crucible) in a furnace. The melt is maintained at a peak temperature of 1100° C.-1400° C. for at least one hour, followed by melt quenching in water, collecting the crude frit and milling same, as described in more detail below.

The coating compositions of the invention are prepared by combining together the silicone resin solution and if required one or more auxiliary solvents such as terpineol, dibutyl carbitol or benzyl alcohol, and the solids consisting of the glass constituent and the black pigment(s), i.e., either black ruthenium oxide, black spinel or a combination thereof, to form a uniform formulation preferably with paint consistency, such that it can be applied onto a substrate by conventional painting techniques such as brushing, dipping and spraying.

The weight concentration of the silicone resin solution in the coating composition of the invention is adjusted to produce the desired consistency, which can be further modified by addition the aforementioned auxiliary solvent(s). The surface area of the solids incorporated in the composition affects the liquid to solid weight ratio. In general, the higher the surface area of the particles, the larger the amount of silicone resin solution used. Preferably, the weight ratio between the liquid and solid components of the formulation is in the range from 1:2 to 2:1, more preferably from 0.7:1.0 to 1.25:1. The presence of surfactants in the formulation may also affect the liquid/solid ratio.

The concentration of the ruthenium compound(s) in the solids can range from 0 to 100% by weight, e.g., from 0 to 80% by weight, preferably from 2 to 50% by weight. The concentration of the spinel pigment relative to the total weight of the solids is from 0 to 100 wt %, e.g., from 0 to 80% wt % or from to 100 wt %. The glass powder concentration in the solids may range from 0 to 50 wt %; for formulations for high temperatures the desired range is from 5 to 60 wt %, e.g., 5 to 50 wt % of the solids (consisting of the ruthenium compound(s), the black spinel and the glass).

The silicone-based paint of the invention can be used for coating iron, steel substrates and special alloys for absorption of solar energy, especially solar applications such as generation of electricity in solar towers and Stirling engines and solar heaters for domestic uses. The coating is dried and then heat-cured at a temperature of not more than 400° C. for several hours. Typical preparation of coated stainless steel substrate is as follows: the paint is applied onto stainless steel substrate using a brush and the fresh paint is left for about 15 minutes in the hood to level. The coated substrate is then dried by placing same in an oven at T₁, wherein 100≦T₁≦150° C., for example, T₁=120° C., for a period of time t₁ which is not less than 10 minutes, e.g., 20 minutes, to evaporate the volatiles (solvents). The dried coated substrate is transferred to an electric furnace where it undergoes heat-curing. To this end, the coated substrate is kept in at least two different temperatures in the range from 200 to 400° C. for a period of time of not less than 30 minutes at each of said temperatures. More specifically, the coated substrate is gradually brought to a temperature T₂, wherein 150≦T₂≦300° C., for example T₂=250° C., and kept at T₂ for a period of time t₂ of not less than 45 minutes, for example 1 hour. Then the temperature of the furnace is increased to T₃, wherein 200≦T₃≦400° C.; preferably T₃=375-400° C., and the coated substrate is kept at T₃ for a period of time t₃ of not less than 45 minutes, e.g. 1 hour. Temperature variation T₁→T₂→T₃ is carried out at constant rate of not more than 30 deg/min, for example, about 20 deg/min.

The coated substrate is slowly cooled to room temperature. In the curing stage traces of the solvents evaporate and the silicone resin undergoes cross-linking forming a polymer which bonds to the metallic substrate and to the inorganic phases. During the curing stage some of the organic constituents probably oxidize to water and carbon dioxide.

After curing the coating may be exposed to a higher temperature in the range of 500−700° C. to convert the siloxane into amorphous SiO₂. At the 500-700° C. range the indigenously-formed SiO₂ (and also the quartz accompanying the black pigment) dissolve in the glass component of the coating and modify its properties, forming a high temperature ceramic coating based on rich-SiO₂ glass characterized by SiO₂ mole concentration above 60 mole %, preferably above 65 mole %, e.g., from 65 to 75 mole %, more specifically 66-75 mole %. The SiO₂ concentration in the modified glass is calculated based on the weight of the glass in the paint and the total weight of silicone resin in the paint.

Accordingly, another aspect of the invention is a method comprising applying a coating composition, e.g., the paint formulation, onto a metal substrate in a solar collector, drying the coating and heat-curing the dried coating (including on-site heat-curing), and optionally firing same. The substrate to be coated is preferably steel, such as carbon steel, stainless steel, Inconel™ (nickel-chromium based alloys) and other alloys which are useful at high temperatures.

The experimental results reported below indicate that a coating composition comprising a silicone resin solution formulated either with black ruthenium compound(s), black spinel or their combination (e.g., a combination consisting of RuO₂, BaRuO₃ or Nd_{1.75}Cu_{0.25}Ru₂O_{6+δ} together with a black spinel which is preferably cobalt-iron-chromium mixed oxide), and a glass comprising 35 to 45 mole % SiO₂ (e.g., 35 to 39 or 35 to 40 mole % SiO₂), 15 to 20 mole % TiO₂; 8 to 15 mole % K₂O; 10 to 22 mole % Na₂O; 3 to 11 mole % Li₂O; 3 to 7 mole % B₂O₃; 1 to 3 mole % SnO₂; and one or more of the following oxides: 0.5 to 2 mole % Al₂O₃; 0.5 to 2 mole % Bi₂O₃ and 0.5 to 2 mole % ZrO₂;

forms on curing a solar absorber coating with good color properties and high adhesive strength. A solar collector having a cured coating with the composition set forth above forms another aspect of the invention.

The invention also provides a solar collector having a fired coating applied thereon, said coating comprising a compound selected from the group consisting of black ruthenium oxide, black spinel and their mixture and either non-crystallizable or crystallized SiO₂-rich glass, with higher SiO₂ content than the starting glass composition, e.g., of not less than 60 mole %, preferably above 65 mole %, e.g., from 65 to 75 mole %. Some preferred compositions of this rich-SiO₂ glass component of the ceramic coating are set out in Table 2.

TABLE 2
(composition of the rich-SiO₂ glass component of
the high temperature (500-700° C.) ceramic coatings)

| Ingredients | Range in mole % | Preferred range in mole % |
|---|---|---|
| SiO₂ | 60-75 | 65-75 |
| TiO₂ | 5-15 | 7-12 |
| K₂O | 5-15 | 6-10 |
| Na₂O | 7-20 | 8-18 |
| Li2O | 2-10 | 3-7 |
| B₂O₃ | 2-10 | 2-7 |
| Bi₂O₃ | 0-2 | 0.2-1.0 |
| ZrO₂ | 0-2 | 0.2-1.0 |
| Al₂O₃ | 1-4 | 0.5-3.0 |
| SnO₂ | 1-4 | 0.5-3.0 |

### EXAMPLES

### Preparation 1

### Silicone-Based Vehicle

A commercially available silicone-based heat resistant paint (Pyromark® 2500) was passed through a filter paper. The filtrate which consists of solvents and siloxane was slowly dried to remove most of the solvents, resulting in a resinous material. The resinous material was dissolved is a solvent and was subjected to nuclear magnetic resonance (NMR) analysis to determine the structure of its main component, i.e., the silicone resin. The NMR data indicated the presence of phenyl and methyl groups in the silicone resin. The filtrate (which in addition to the silicone resin contains also organic solvents and surfactants) was used in the experimental work described below as a vehicle to form coatings (hereinafter the silicone vehicle).

### Preparation 2

### Glass Powder Compositions

Glass compositions (coded herein Glass X₁, X₂ and X₃) were prepared in a platinum crucible at 1100° C.-1400° C. The compositions of the glasses are specified below in terms of mole % of each ingredient present in the glass:

| Ingredients | Glass X₁ | Glass X₂ | Glass X₃ |
|---|---|---|---|
| SiO₂ | 38.71 | 33.0 | 34.02 |
| TiO₂ | 16.13 | 17.0 | 17.53 |
| K₂O | 12.92 | 8.0 | 8.25 |
| Na₂O | 17.20 | 20.0 | 20.62 |
| Li₂O | 5.38 | 10.0 | 10.31 |
| B₂O₃ | 4.30 | 5.0 | 5.15 |
| Bi₂O₃ | 1.08 | 1.0 | — |
| ZrO₂ | 1.08 | — | — |
| Al₂O₃ | 1.08 | 1.0 | 1.03 |
| SnO₂ | 2.15 | 2.0 | 2.06 |
| Nb₂O₅ | — | 1.0 | 1.03 |
| CoO | — | 2.0 | — |

To prepare the glasses, the metal compounds powders are premixed by shaking in a polyethylene jar with plastic balls, and are then melted in a platinum crucible. The melt is maintained at a peak temperature of 1100° C.-1400° C. for a period of 1.5 to 3.0 hours. The melt is then poured into cold water. The maximum temperature of the water during quenching is kept as low as possible by increasing the volume of water to melt ratio. The crude frit after separation from water is freed from residual water by drying in air, or by displacing the water by rinsing with methanol. The crude frit is then ball milled for 3-24 hours in alumina containers using alumina balls. Alumina picked up by the materials, if any, is not within the observable limit as measured by X-ray diffraction analysis. After discharging the milled slurry from the frit, the powder is air-dried at room temperature. The dried powder is then screened through a 325 mesh screen to remove any large particles.

### Preparation 3

### Spinel Pigment

One mole of CuO and two moles of MnO were ball milled with 225 g of water for 3 hrs, slip separated and dried at 150° C. The dried mixture was heated in Pt crucible at 900° C. for 64 hours and further heated at 950° C. for 15 hrs, and then ball milled to obtain a fine powder. XRD shows that the product consists mainly of spinel CuMn₂O₄, but that a phase of Mn₃O₄ is also present. The color of the material is dark brown.

### Preparation 4

### Ruthenium Compounds

Nd_{1.75}Cu_{0.25}Ru₂O_{6+δ} was prepared as described in U.S. Pat. No. 6,989,111 (J. Hormadaly), entitled “Thick Film Compositions Containing Pyrochlore-Related Compounds”.

BaRuO₃ was prepared as described by Donohue et al. [The Crystal Structure of Barium Ruthenium Oxide and Related Compounds, Inorg. Chem., 1965, 4 (3), pp 306-310].

### Examples 1-3

### Preparation and Properties of a Cured Coating Obtained from a Silicone Vehicle Formulated with Pigments

Three inorganic compounds were tested to assess their ability to function as pigments in a silicone-based heat resistant paint. The inorganic compounds are:

A) black spinel of the formula (Co,Fe) (Fe,Cr)O₄, commercially available from Ferro Corporation (F6333).

B) dark brown spinel of the formula CuMn₂O₄, synthesized as described in Preparation 3.

C) RuO₂, commercially available.

Each of the inorganic compounds A, B and C was ground with the silicone vehicle of Preparation 1 in an agate mortar. The compositions are tabulated in Examples 1-3, respectively.

The compositions of Examples 1-3 were brushed on stainless steel 304 substrates, to form a set of samples, each with a uniform coating applied onto 5×5 cm² surface area of the metal substrate. The substrates were dried in an oven at 150° C. for minutes. All samples were then heat-cured; the dried substrates were placed in a furnace and were exposed to the following temperature profile:

heating to 250° C. at a constant heating rate of 20° C./min;

keeping the substrate in 250° C. for one hour;

heating to 400° C. at a constant heating rate of 20° C./min;

keeping the substrate in 400° C. for one hour.

Some samples were held for an additional hour in the furnace at temperature of 500° C.

The samples were then subjected to a color test and an adhesion strength test, to determine if the compound is suitable for pigmenting the silicone resin and to assess the effect of holding the coated substrate at 500° C. for an additional hour.

In the color test, the samples were visually inspected to determine whether the original black color of the formulation remained unchanged after curing, or if color transition or hue changes occurred.

In the adhesion strength test, the adhesion of the cured paint was tested by applying an adhesive tape on the cured paint. The paints were rated “marginal”, “not good” or “good”.

TABLE 3

| | | |
|---|---|---|
| Example 1 | Example 2 | Example 3 |

Composition

| | | | |
|---|---|---|---|
| Silicone vehicle | 5.34 g | 3.3 g | 3.59 g |
| Compound A | 5.0 g | | |
| Compound B | | 5.0 g | |
| Compound C | | | 2.50 g |

Properties

| | | | |
|---|---|---|---|
| color test after | gray | Brown | black |
| curing at 400° C. | | | |
| adhesion test after | marginal | good | not good |
| curing at 400° C. | | | |
| color test after | black | brown | black |
| curing at 400° C. and 1 | | | |
| hour holding at 500° C. | | | |
| adhesion test after | good | good | good |
| curing at 400° C. and 1 | | | |
| hour holding at 500° C. | | | |

The results reported above indicate that methyl phenyl silicone resin can be formulated with a black spinel of the formula (Co,Fe) (Fe,Cr)O₄ and/or with RuO₂, to form black coatings with high adhesive strength.

### Examples 4-5

### Preparation and Properties of a Cured Coating Obtained from a Silicone Resin Formulated with a Pigment and a Glass

The black pigment ((Co,Fe) (Fe,Cr)O₄; F6333) and the glass powder X1 of Preparation 2 were ground with the silicone-containing vehicle of Preparation 1 in an agate mortar. Two different formulations were prepared, as set out in Table 4 below. The formulations were applied onto a stainless steel 304 substrate, and the coated metal pieces were placed in the furnace, to be heat-cured according to the temperature regimen described in the foregoing set of examples. However, due to a power problem, the temperature in the furnace rose to 670° C., following which the furnace was turned off. The accidentally-made samples were removed from the furnace and were tested to assess the color and adhesion strength of the so-formed paints. The formulations of both Examples 4 and 5 lead to the formation of black coatings displaying strong adhesion to the metal surface. Visual inspection of the coatings indicates a formation of a glaze-like layer in the case of Example 4 and darker matt black color in the case of Example 5. The results indicate that the formulated compositions with the tested pigment and glass can survive high temperatures, at least 670° C., to form durable black films. At temperatures higher than 400° C. the silicone resin converts to a white powder which was identified (XRD) as amorphous SiO₂. The stability at high temperatures (670° C.) is probably due to a glass component which softens, dissolves some or all of the amorphous SiO₂, bonds to the metallic substrate and the inorganic ingredients, forming either a modified non-crystallizable glass form, or a partially crystallizable glass during the hold-up at the high temperature range (>600° C.)

To test the properties of paints cured in accordance with the planned curing process described in Examples 1 to 3, the two formulations were again brushed on stainless steel substrates to form samples, which were subjected to the normal curing process. The formulations and test results are tabulated below.

TABLE 4

| | |
|---|---|
| Example 4 | Example 5 |

Composition

| | | |
|---|---|---|
| Silicone vehicle | 4.0 g | 4.5 g |
| black pigment F6333 | 2.5 g | 3.0 g |
| Glass X1 of Preparation 1 | 2.5 g | 2.0 g |

Properties

| | | |
|---|---|---|
| Adhesion test after curing at 400° C. | good | good |
| Color test after curing at 400° C. | black | black |

### Examples 6-11

### Preparation and Properties of a Cured Coating Obtained from a Silicone Resin Formulated with Pigment(s) and a Glass

Additional formulations were prepared by grinding solids consisting of the glass powder X₁ of Preparation 2 and one or two black compounds [either an oxide of ruthenium alone, or in combination with the black spinel (Co,Fe) (Fe,Cr)O₄, F6333)], with the silicone resin of Preparation 1 in an agate mortar to form homogeneous mixtures. The so-formed formulations were then applied onto the stainless steel substrates, and the coated metal pieces were heat-cured according to the curing protocol set forth in Examples 1-3. The cured paints were then examined to determine their color and adhesion properties. The composition of each of the paint formulations prepared and the characteristics of the paints obtained on applying and curing the formulations are tabulated below.

TABLE 5

| | | | | | |
|---|---|---|---|---|---|
| Ex. 6 | Ex. 7 | Ex. 8 | Ex. 9 | Ex. 10 | Ex. 11 |

Composition

| | | | | | | |
|---|---|---|---|---|---|---|
| Silicone vehicle | 4.0 g | 4.0 g | 4.0 g | 4.0 g | 3.5 g | 3.0 g |
| Glass X₁ | 2.5 g | 2.5 | 2.5 g | 2.5 g | 2.5 g | 2.5 g |
| RuO₂ | 2.5 g | — | — | 1.0 | — | — |
| Nd_{1.75}Cu_{0.25}Ru₂O_{6+δ} | — | 2.5 g | — | — | 1.0 g | — |
| BaRuO₃ | — | — | 2.5 | — | — | 1.0 g |
| Black pigment F6333 | — | — | — | 1.5 g | 1.5 g | 1.5 g |

Properties

| | | | | | | |
|---|---|---|---|---|---|---|
| color test after | black | Black | Black | Black | Black | black |
| curing at 400° C. | | | | | | |
| adhesion test after | Not | good | Not | good | good | good |
| curing at 400° C. | good | | good | | | |
| color test after | Black | Black | Black | Black | Black | black |
| curing at 400° C. and | | | | | | |
| 1 hour holding at | | | | | | |
| 500° C. | | | | | | |
| adhesion test after | Good | Good | Good | Good | Good | good |
| curing at 400° C. and | | | | | | |
| 1 hour holding at | | | | | | |
| 500° C. | | | | | | |

The results shown in Table 5 indicate that the silicone resin can be formulated with black oxides of ruthenium and glass to form coatings displaying strong adhesion to stainless steel and acceptable black color, provided that the cured paints are further exposed to a temperature above 400° C. (e.g., 500° C.) for a sufficient time. Notably, in the case of Nd_{1.75}Cu_{0.25}Ru₂O_{6+δ}, the desired properties of the film are achieved following curing at a temperature not higher than 400° C.

The results also illustrate that the silicone resin can be formulated with glass powder and a combination consisting of ruthenium oxide and a black spinel, which on curing at a temperature not higher than 400° C., produces a coating with particularly intense black color which strongly adheres to the metal surface.

### Example 12

The solution of Preparation 1 was subjected to several heating schedules to estimate weight loss and finally heated for 1 hour at 700° C. in air, to achieve conversion to SiO₂. Three samples underwent the treatment, and the results reported below are the averaged weight loss for these three samples.

After 0.5 hour at 150° C., the solution of Preparation 1 shows a weight loss of 62.34%. At 150° C., most of the volatile solvents evaporate.

The same three samples were then subjected to a heating profile consisting of 1 hour at 250° C. and 1 hour at 400° C., ramps up and down were 20 C/min. Average weight loss between 150° C. and the two ramps profile was 32.25%. After the heating at 400° C., the samples consist only of a resinous material, which was partially cross-linked.

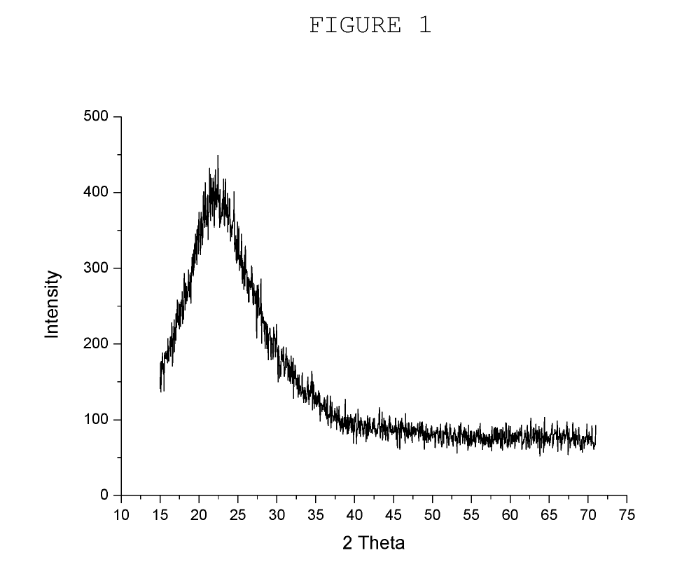

The same three samples were then subjected to 1 hour at 700° C. A white powder was formed. The X-ray powder diffraction of the so-formed white powder is shown in FIG. 1, and is typical of an amorphous material.

The average weight loss of the three samples between 400° C. to 700° C. was 47.0%, meaning that the resinous material formed after 400° C. was converted to SiO₂ and the conversion was 53.0%.

This experimental result is in agreement with the following considerations. Assuming that the repeating unit(mer) in the polysiloxane is Si—O(CH₃) (C₆H₅) and the polymer consists of a linear long chain, then it could be estimated that the repeating unit (formula weight of 136.086) converts to one unit of SiO₂ (formula weight of 60.086) after exposure to high temperature in the range of 500-700 C; i.e. 44.2% of the resin will convert to SiO₂. Commercial silicones used for high temperature applications have short branched chains which contain OH groups. Therefore, a higher conversion to SiO₂ is expected, probably around 50%.

### Example 13

This example illustrates the marked change which occurs in the composition of a glass combined with a silicone resin, following the transformation of the resin into SiO₂ at high temperatures, leading the incorporation of this indigenously-formed SiO₂ into the glass to produce a modified glass.

A typical paint formulation containing ruthenium dioxide, black spinel (Co,Fe) (Fe,Cr)O₄, glass X₁, a commercial silicone resin and solvents was prepared. The total weight of the solids used was 52.5 g, with the concentration of the glass in the solids being 50 wt % (i.e., 26.25 g glass X₁ in 52.5 g solids). The concentration of the solids in the paint formulation was 42.82 wt %. The weight of commercial silicone resin solution used to prepare the formulation was 70.10 g (57.18% of the paint formulation). The so-formed formulation is used to illustrate the composition of the modified glass, taking into account that the commercial silicone resin solution contains 50 wt % resin and the resin has 53% conversion to SiO₂ as described in Example 12, i.e., the 70.1 g commercial silicone resin solution will convert to 18.6 g of silica powder (70.1 g×0.5×0.53=18.6 g) after one hour at 600-700° C. The indigenously-formed SiO₂ (18.6 g) combines with the softened glass in the temperature range of 600-700° C. The dissolution of the indigenously-formed SiO₂ into glass X₁ will be a function of time in the temperature range of 600-700° C. The compositions of the original glass component (Glass X₁) of the formulation and the modified glass are set out in Table 6.

TABLE 6

| | | | | Glass component of heat- | |
|---|---|---|---|---|---|
| | Glass X₁ | | | treated mixture of | |
| | Batch | Glass X₁ | | siloxane and glass X₁ | |
| Ingredients | (g) | wt % | mol % | wt % | mol % |
| SiO₂ | 86.52 | 31.33 | 38.71 | 59.82 | 68.41 |
| TiO₂ | 47.94 | 17.36 | 16.13 | 10.16 | 8.73 |
| K₂O | 45.22 | 16.38 | 12.90 | 9.58 | 6.98 |
| Na₂O | 39.68 | 14.37 | 17.21 | 8.41 | 9.31 |
| Li₂O | 5.98 | 2.17 | 5.38 | 1.27 | 2.92 |
| B₂O₃ | 11.11 | 4.02 | 4.29 | 2.35 | 2.32 |
| Bi₂O₃ | 18.64 | 6.75 | 1.08 | 3.95 | 0.33 |
| ZrO₂ | 4.93 | 1.78 | 1.08 | 1.04 | 0.30 |
| Al₂O3 | 4.08 | 1.48 | 1.08 | 0.87 | 0.59 |
| SnO₂ | 12.05 | 4.36 | 2.14 | 2.55 | 1.16 |

As shown in Table 6, due to the incorporation of the indigenously-formed SiO₂ into the glass component, rich-SiO₂ glass is generated, with SiO₂ content above 65 mole %.

1. A composition for producing a solar absorber coating,
comprising a silicone resin formulated with:
(i) at least one compound selected from the group consisting of black ruthenium oxides and black spinel; and
(ii) a glass powder.

2. A composition according to claim 1, wherein the silicone resin has aryl groups attached to the silicone backbone.

3. A composition according to claim 2, wherein the silicone resin is selected from the group consisting of poly (methylphenylsiloxane) and poly (diphenylsiloxane).

4. A composition according to claim 1, comprising black ruthenium oxide selected from the group consisting of:
ruthenium dioxide (RUO₂);
ruthenium-containing pervoskite of the formula M′RuO₃, wherein M′ is either Ca, Sr or Ba; and
ruthenium-containing lead-free pyroclores.

5. A composition according to claim 4, wherein the black ruthenium oxide is selected from the group consisting of:
Ru0₂;
ruthenium-containing pervoskite which is BaRuO₃; and
ruthenium-containing lead-free pyroclores which is Nd_{1.75}CU_{0.25}RU₂O_{6+δ}.

6. A composition according to claim 1, comprising black spinel of the formula AB₂O₄ wherein the divalent and trivalent cations are selected from the group consisting of Cu²⁺, Co²⁺, Fe²⁺, Mn²⁺, Ni²⁺, Fe³⁺, Cr³⁺ and Mn³⁺.

7. A composition according to claim 6, wherein the black spinel is cobalt-iron-chromium mixed oxide with spinel structure.

8. A composition according to claim 1, comprising a combination of ruthenium oxide and black spinel.

9. A composition according to claim 8, comprising ruthenium oxide selected from the group consisting of RUO₂, BaRuO₃ and Nd_{1.75}Cu_{0.25}Ru₂O_{6+δ} and black spinel which is cobalt-iron-chromium mixed oxide with spinel structure.

10. A paint composition according to claim 1, wherein the glass powder comprises 25.0 to 50.0 mole % silicon dioxide, 5.5 to 35.0% mole % titanium dioxide and 19.0 to 45.0 mole % alkali metal oxides.

11. A paint composition according to claim 10, wherein the glass powder further comprises one or more additional glass components selected from the group consisting of boric oxide B₂O₃, bismuth oxide Bi₂O₃, aluminum oxide Al₂O₃, tin dioxide SnO₂, zirconium dioxide ZrO₂ and niobium oxide Nb₂O₅.

12. A paint composition according to claim 10, wherein the glass powder comprises:
30 to 45 mole % S₁O₂;
15 to 20 mole % TiO₂;
35 to 45 mole % M₂O wherein M is Na, K, Li or their mixture; 3 to 7 mole % B₂0₃;
0.5 to 4 mole % SnO₂; and one or more of the following oxides:
0.5 to 4 mole % A1₂0₃; 0 to 2 mole % Bi₂0₃ and 0 to 2 mole % Zr0₂.

13. A paint composition according to claim 12, wherein the glass powder comprises:
35 to 40 mole % Si02;
15 to 20 mole % Ti02;
8 to 15 mole % K20, 10 to 22 mole % Na20, 3 to 11 mole % Li20;
3 to 7 mole % B203;
1 to 3 mole % Sn02;
0.5 to 4 mole % A1203;
0.5 to 2 mole % Bi2O3; and
0.5 to 2 mole % Zr0₂.

14. A method comprising applying the coating composition of claim 1 onto a substrate in a solar collector, drying and heat-curing said composition and optionally firing the same.

15. A solar collector having a fired coating applied thereon, said coating comprising a compound selected from the group consisting of black ruthenium oxides, black spinel and their mixture and either non-crystallizable or crystallized Si0₂-rich glass, with Si0₂ concentration in the glass being higher than 65 mole %.

16. A composition according to claim 1, wherein the concentration of the black ruthenium oxide (s) is the mixture of solids consisting of said black ruthenium oxide (s), the black spinel and the glass powder is from 0 to 80 wt %.

17. A composition according to claim 1, wherein the concentration of the black spinel in the mixture of solids consisting of the black ruthenium oxides, said black spinel and the glass powder is from 0 to 80 wt %.

18. A composition according to claim 1, wherein the concentration of the glass powder in the mixture of solids consisting of the black ruthenium oxide (s), black spinel and said glass powder is from 5 to 60 wt %.
